(19) United States
(12) Patent Application Publication
(10) Pub. No.: US 2016/0293966 A1
(43) Pub. Date: Oct. 6, 2016

(54) FUEL CELL HAVING CATALYST-SUPPORT MATERIAL WITH SELF-HEALING PROPERTIES, AND METHOD OF FABRICATION THEREOF

(71) Applicant: Florida Polytechnic University, Lakeland, FL (US)

(72) Inventors: Jaspreet Singh Dhau, Tampa, FL (US); Sesha Srinivasan, Lakeland, FL (US); Ghazi Darkazalli, Lakeland, FL (US)

(21) Appl. No.: 15/087,431

(22) Filed: Mar. 31, 2016

Related U.S. Application Data
(60) Provisional application No. 62/140,973, filed on Mar. 31, 2015.

(51) Int. Cl. H01M 4/88; H01M 4/90

(52) U.S. Cl. CPC H01M 4/8878; H01M 4/9075; H01M 4/9083

(57) ABSTRACT

A fuel cell catalyst support material with self-healing and service on the fly properties. The material is stable and can preserve a fuel cell's activity over an extended lifetime. The approach strikes a practical balance between the optimum size of the electrocatalyst particle and the ability of the support material to self-heal under electrochemical stress. The self-healing support material allows the use of very small catalyst particles size without affecting the fuel cell's durability. This not only increases the efficiency of the fuel cell but also allows low PGM loading.

### CROSS-REFERENCE TO RELATED APPLICATIONS

This nonprovisional application claims priority to U.S. Provisional Patent Application No. 62/140,973, entitled “Fabrication of Advanced Catalyst-Support Material with Self-Healing Properties for Fuel Cells”, filed Mar. 31, 2015 by the same inventors, the entirety of which is incorporated herein by reference.

### BACKGROUND OF THE INVENTION

1. Field of the Invention

This invention relates, generally, to fuel cells. More specifically, it relates to catalyst-support material found in fuel cells.

2. Brief Description of the Prior Art

Durability of the fuel cell is the main hindrance in the commercialization of the fuel cell technologies. Degradation in the catalytic activity of the electrocatalyst, dispersed on a support substrate (carbon support), under aggressive fuel cell operation conditions leads to efficiency losses of the fuel cell. The efficiency losses eventually reach an unacceptable level at which point the life of the fuel cell is effectively over.

Most of the research concerning the increase in the activity of the electrocatalyst is centered on increasing its surface area by decreasing the size of the electrocatalyst moieties anchored on the support material. High catalyst surface area does improve catalyst efficiency and help in reducing the catalyst loading. However, a very active catalyst particle is also responsible for damaging the support material leading to its oxidative degradation. The resulting loss of the electrochemically active surface area (ECSA) partially or completely paralyses the fuel cell. The oxidative degradation of the support material is considered the primary degradation phenomenon, which decreases the fuel cell efficiency over repeated use.

Accordingly, what is needed is a stable fuel cell catalyst-support material, which can preserve its activity over an extended lifetime. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an improved fuel cell and method of fabrication thereof is now met by a new, useful, and nonobvious invention.

In an embodiment, the current invention is a fuel cell comprising a self-healing catalyst support material including nano- or micro-encapsulated (e.g., via an organic or inorganic shell material) monomers and oligomers containing a conducting polymer (e.g., polyaniline). The nano- or micro-capsules burst into nanofibers of the conducting polymer to fill cracks in the catalyst support material due to oxidative degradation of the catalyst support material at an electrode of the fuel cell. The monomers and oligomers further act as a physical barrier to catalyst agglomeration. The support material may further include graphene oxide reduced with a reducing agent to facilitate the self-healing benefits of the support material. The shell material may incorporate the hydrophobic character in the support material that improves mass activity and decreases the flooding effect at the electrode.

In a separate embodiment, the current invention is fuel cell support material comprising a plurality of nano-reservoirs storing monomers, wherein the nano-reservoirs are adapted to release the monomers upon corrosion of the support material and the monomers are convertible into nanofibers when subject to a radical rich oxidative environment at an electrode of a fuel cell.

In a separate embodiment, the current invention is a method of generating nanofibers of conducting polymers in a fuel cell in situ. The method includes encapsulating a plurality of monomers and oligomers with an organic or inorganic shell material and storing the monomers and oligomers in a plurality of micro- or nano-reservoirs. The monomers and oligomers include a conducting polymer that converts into nanofibers when subject to a radical rich oxidative environment at an electrode of the fuel cell. The reservoirs develop micro-cracks at their outer surfaces to release the monomers and oligomers as a result of degradation (e.g., cracks in the substrate or support material) of a substrate or support material in the fuel cell. The monomers and oligomers flow into the support material cracks to react with the radical rich oxidative environment and generate the nanofibers of the conductive polymer in The nanofibers plug the cracks and reverse the degradation by re-bonding the cracks, and preventing shrinkage of the support material and dislocation of the electrocatalyst without affecting the conductivity of the support material.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is an illustration of an embodiment of the method of the present invention.

FIG. 2 is a flow chart of an embodiment of the present invention.

FIG. 3 depicts PANI BB nanofibers by stirring at room temperature only.

FIG. 4 depicts PANI CC nanofibers by stirring at room temperature only.

FIG. 5 depicts PANI DD nanofibers by stifling at room temperature only.

FIG. 6 depicts PANI BB nanofibers by constant stirring while refrigerating.

FIG. 7 depicts PANI BB nanofibers by constant stirring while refrigerating.

FIG. 8 depicts emergence of PANI blooms.

FIG. 9 depicts PANI blooms.

FIG. 10 depicts PANI blooms close-up showing fiber sprouts.

FIG. 11 depicts PANI nanofibers formed by direct dump method.

FIG. 12 depicts PANI nanofibers formed by direct dump method showing less agglomeration.

FIG. 13 depicts PANI nanofibers formed by direct dump method.

FIG. 14A depicts an EDS spectral response exhibiting both carbon and sulfur peaks.

FIG. 14B depicts carbon peaks.

FIG. 14C depicts sulfur peaks.

FIG. 15 depicts a map sum spectrum.

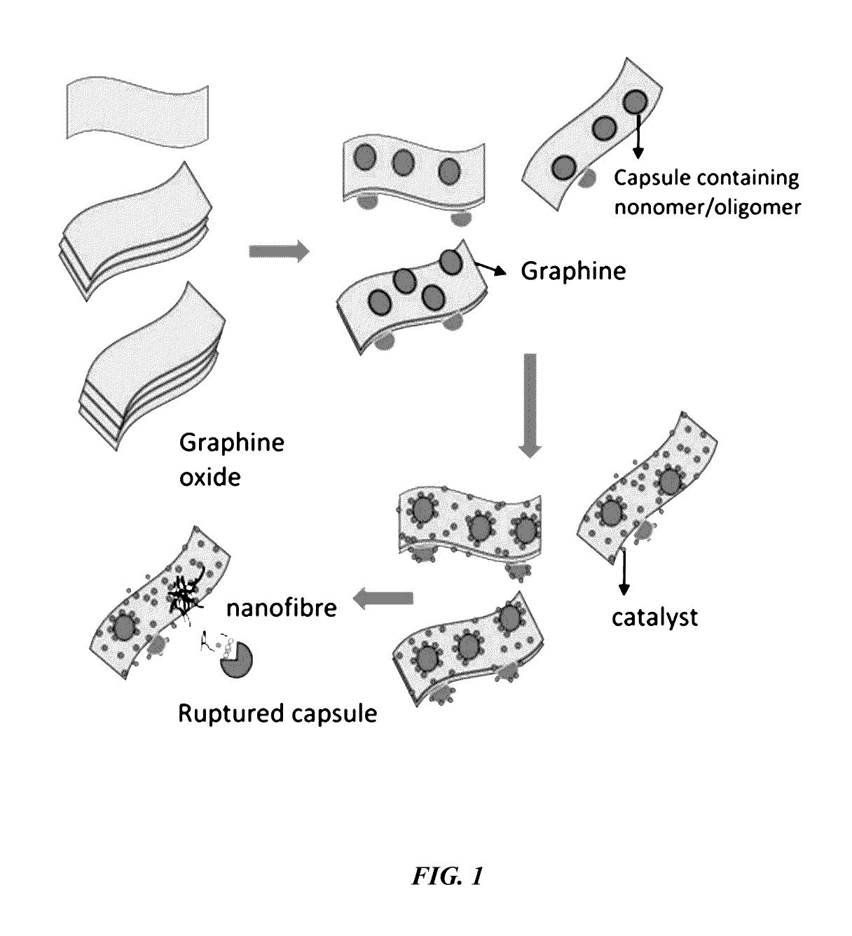

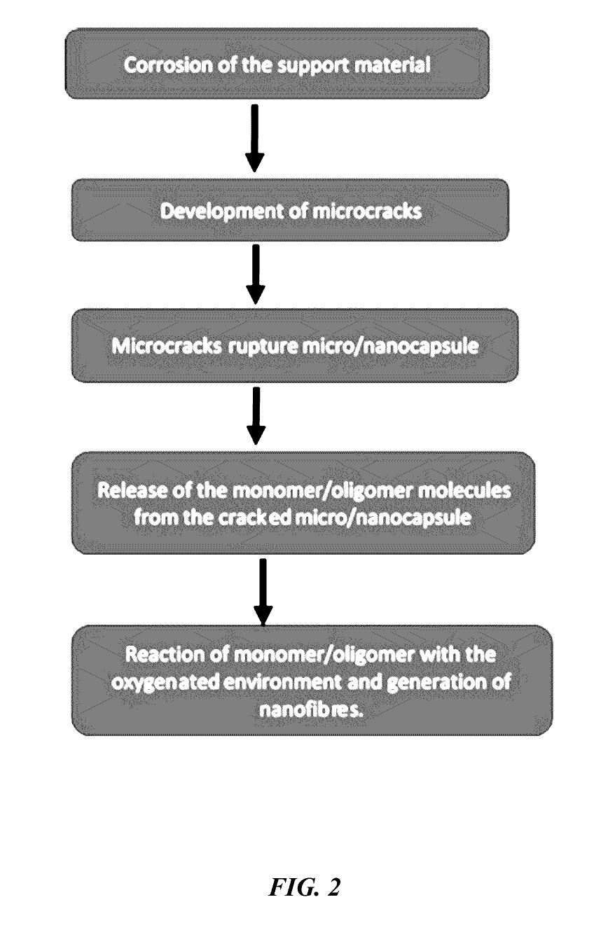

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

In certain embodiments, the instant invention is a catalyst support material having self-healing and service on the fly properties, where the material thus mitigates the decrease in fuel cell efficiency. The approach strikes a practical balance between the optimum size of the electrocatalyst particle and the ability of the support material to self-heal under electrochemical stress. The use of self-healing support material allows the use of very small catalyst particle sizes without affecting the durability of the fuel cell. This not only increases the efficiency of the fuel cell, but also allows low platinum group metal (PGM) loading.

In certain embodiments, nano-/micro-encapsulated monomers and oligomers of conducting polymers, such as polyaniline, are used for generating a self-healing support material. Nano-/micro-capsules of conducting polymers are prepared by dispersing the monomers/oligomers of the conducting polymer in a solution and coating with an inorganic or organic shell material. A solution of graphene oxide containing the uniformly dispersed microencapsulated self-healing materials is reduced with a reducing agent to obtain the self-healing support material.

The present invention uses an innovative approach to generate, in situ, the nanofibers of conducting polymers, such as polyaniline, to fill the cracks that develop in substrate/support material due to oxidative degradation of the support material. The radical rich oxidative environment at the electrode of the fuel cell, which otherwise degrades the support material, is innovatively used for converting the monomer/oligomer units into the nanofibers of polyaniline and other conducting polymers.

In use, corrosion of the support material initiates the development of micro-cracks at the surface of the micro-/nano-capsules of the monomers, in turn leading to rupturing of the nano-reservoirs where the healing agents monomer/oligomer units) are stored. The monomer/oligomer flows into the crack plane, reacts with the oxygen radicals, and generates nanofibers of the conducting polymer in situ. These nanofibers plug the cracks and reverse the electrochemical damage to the surface of the support structure. These nanofibers re-bond the micro cracks and also prevent the shrinkage of the support material and dislocation of the electrocatalyst without affecting the conductivity of the support material.

In another embodiment, the shell material is chosen to incorporate hydrophobic character in the catalyst-support material that improves the mass activity and decreases the flooding effect at the electrode. The microcapsules are also designed to act as physical barrier to catalyst agglomeration.

Growth of Polyaniline (PANI) Nanofibers

In this study, syntheses of PANI nanofibers were carried out using a chemical method by varying the time and temperature of nucleation. The polymers' growth characteristics and surface morphologies were analyzed. It was found that the formation of nanofibers varies with the nucleating temperature and cross linking time. Growth of dendritic structures and fiber sprouts suggest that the growth kinetics depend very much on the mechanical agitation of the polymer solution during synthesis. PANI nanofibers (NF) with rough surfaces were found to be formed when synthesized with constant agitation at 5° C. On the other hand, smooth PANI NF were formed when synthesized with constant agitation at about 0° C. PANI blooms with fiber sprouts reveal an insight on the actual growth of these nanofibers.

Experiment and Results

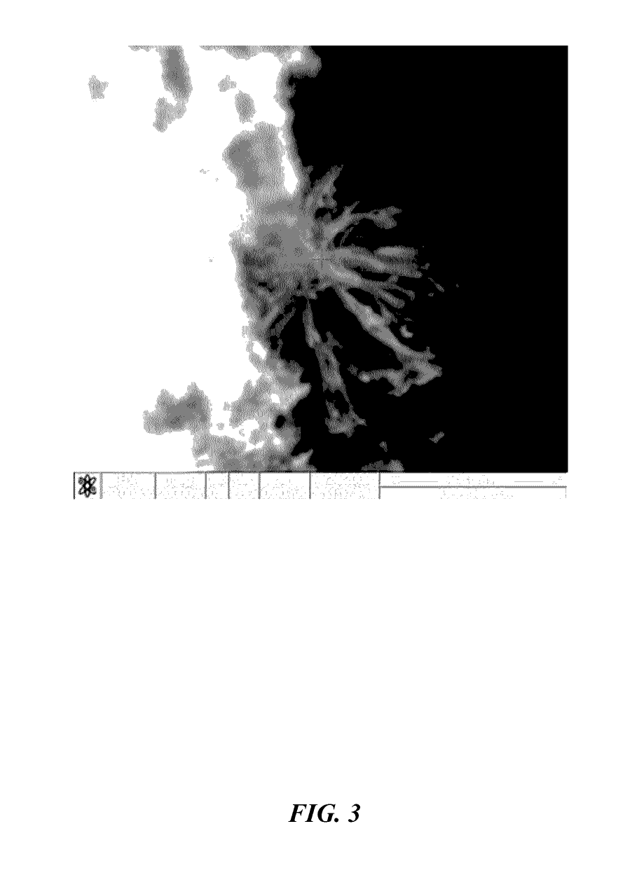

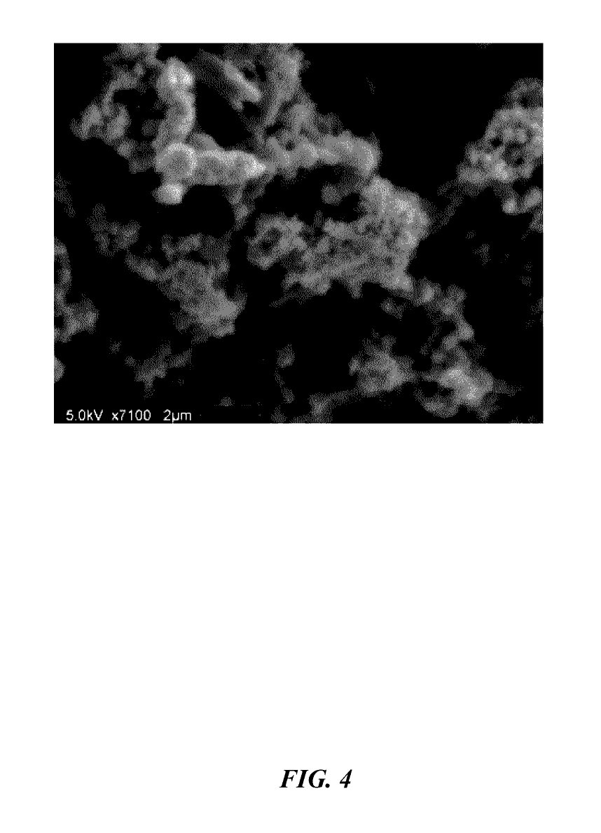

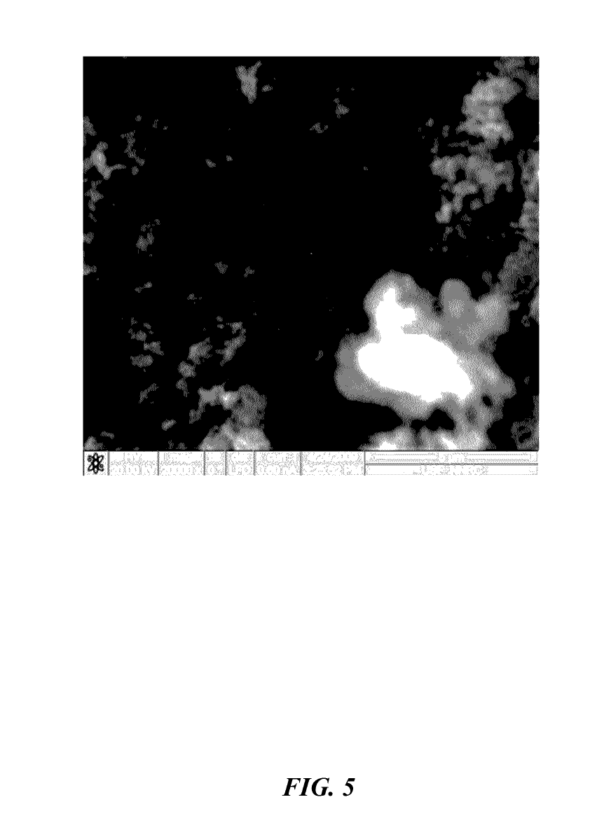

There were three (3) classes of nanofibers synthesized: BB, CC, and DD. The preparation parameters are given in Error! Reference source not found. Out of these three classes, it was found that the BB class gave highly pronounced nanofibers as can be seen in FIG. 3, FIGS. 4 & 5 show classes CC and DD, respectively. Class CC show nano-rods that are blended into the matrix and have little Class DD shows more nanofibers following dendritic structures but their length was limited.

The nanofibers were synthesized by three (3) methods. The first method was by dropwise stirring method. Three solutions were prepared, the first being 0.005 moles of Aniline in 10 ml of deionized (DI) H₂O, the second being 0.0025 moles of CSA in 5 ml of DI H₂O, and the third being 0.005 moles of Ammonium Persulphate (APS) in 5 ml of DI H₂O. Each solution was added to the other dropwise using a burette and with constant stirring. The contents were stirred for about 5 mins and then stored in refrigerator at 5° C. for 15 hrs without stirring. The solution was then removed and filtered using a schlenk apparatus, first with DI H₂O and then with methanol, until the decanted solution was colorless. The precipitate was then dried in a vacuum oven for 3 hrs at 100° C. It was observed that although nanofibers were formed, they were found in clumps and in dispersed through a solid matrix.

TABLE 1
Synthesis parameters of three classes of polyaniline nanofibers.

| Class BB | Class CC | Class DD |
|---|---|---|
| Aniline: 0.005 moles (0.5 ml) | Aniline: 0.005 moles (0.5 ml) | Aniline: 0.005 moles (0.5 ml) |
| in 10 ml DI H2O | in 10 ml DI H2O | in 10 ml DI H2O |
| CSA: 0.0025 moles (0.58 gm) | CSA: 0.005 moles (1.2 gm) in | CSA: 0.0025 moles (0.58 gm) |
| in 5 ml H2O | 5 ml H2O | to 5 ml H2O |
| APS: 0.005 moles (1.14 gm) | APS: 0.0025 moles (0.57 gm) | APS: 0.0025 moles (0.57 gm) |
| in 5 ml H2O | in 5 ml H2O | in 5 ml H2O |

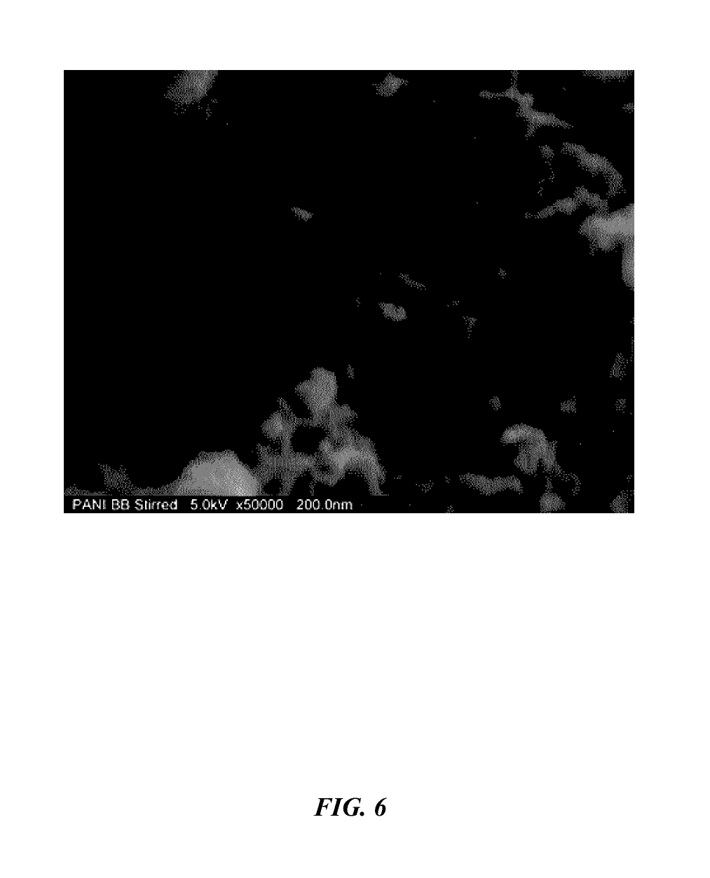

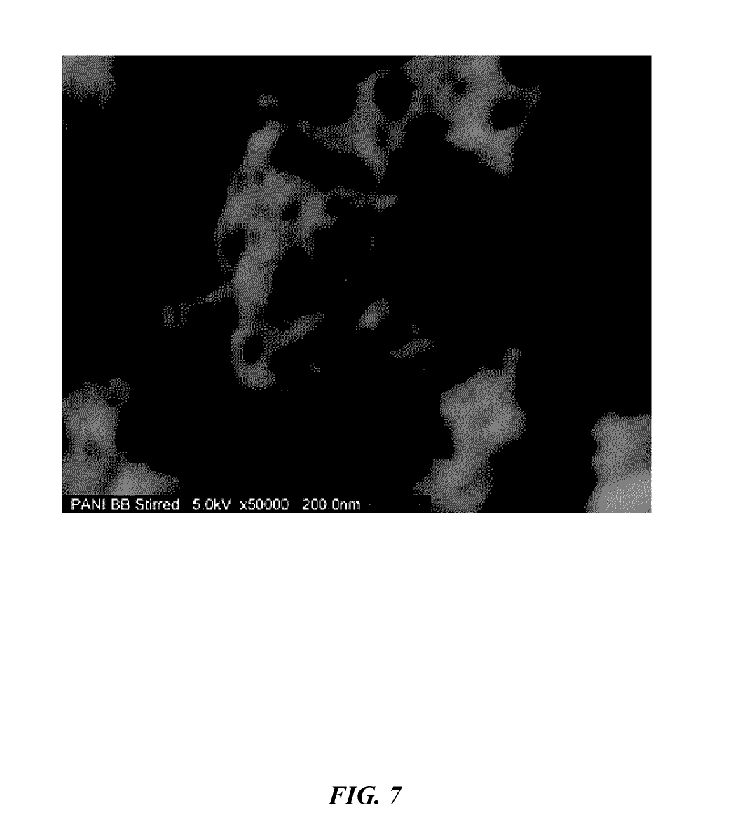

The second method included following the same procedure as above but continuing to stir while refrigerating for 15 hrs at 5° C. This method was applied only to the class BB nanofibers since they were more pronounced as mentioned above. SEM images of these fibers showed interesting results. Not only do they form plentiful fibers as shown in FIGS. 6-7, but they also showed blooms with fiber sprouts. The cause of the blooms and the fibers sprouting out is thought to be controlled nucleation at low temperatures facilitated by constant stirring at 5° C.

It is further speculated that the fiber sprouts continue to grow and break off from the bloom or form a dense matrix covering it. This method provided more fibers than just stirring at room temperature alone, but it also consisted of non-uniform secondary fibers which formed agglomerates dispersed throughout a solid matrix of bulk PANI.

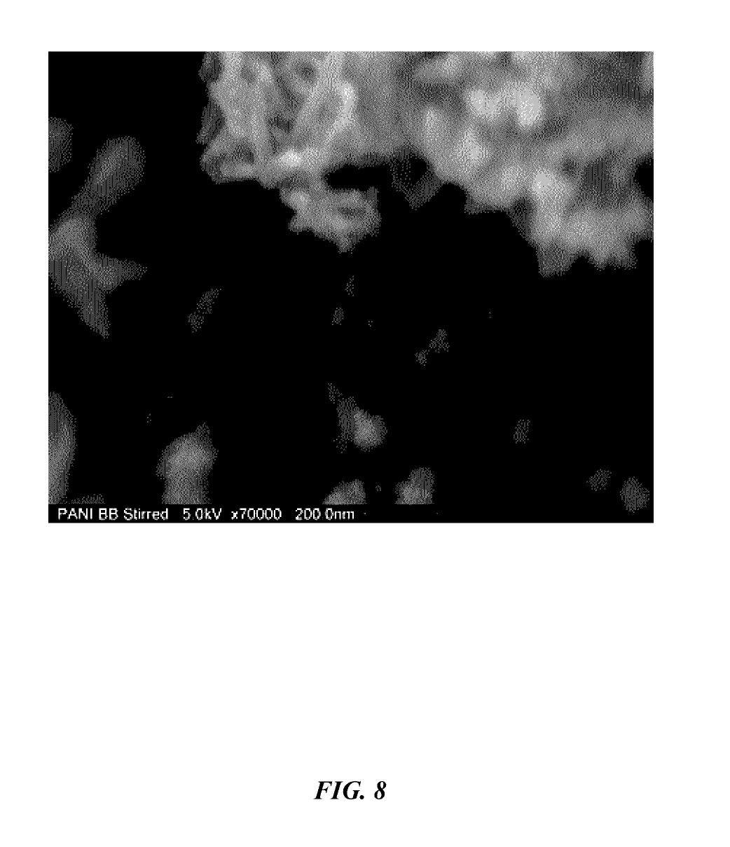

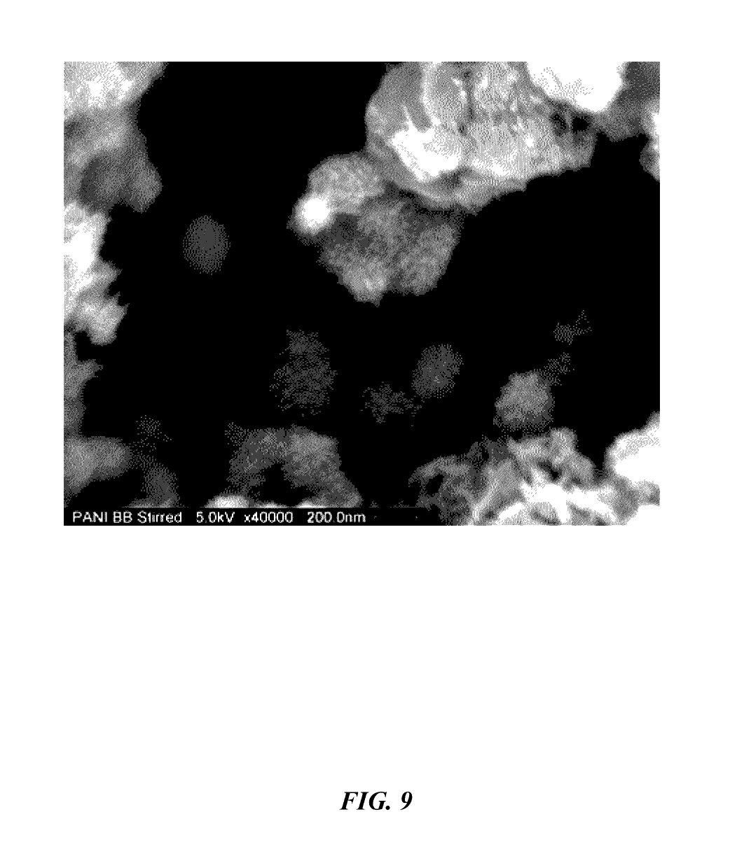

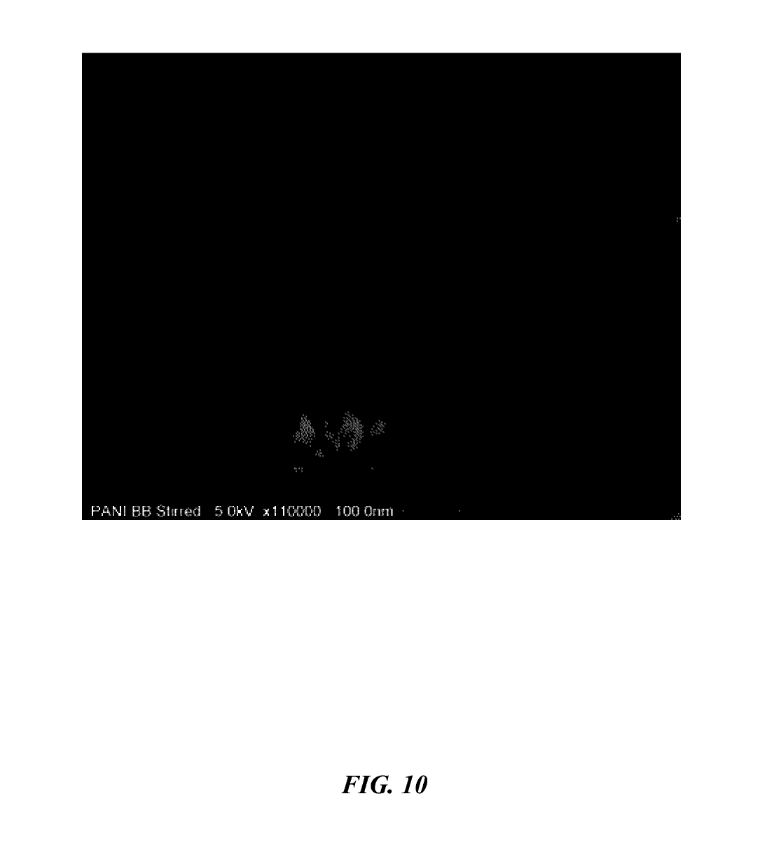

Kaner et al theorized that PANI nanofibers form very early in the reaction and as more APS is consumed, these early nanofibers become precursors for secondary PANI fibers that agglomerate and become bulk PANI. If interfacial polymerization is used, it can suppress secondary growth. Since aniline is in the organic phase and APS in an aquatic phase, polymerization occurs only at this interface. PANI nanofibers are hydrophilic and diffuse into the water after formation [1-4]. Stirring only disturbs this interface and causes secondary growth to occur on the formed nanofibers. See FIGS. 8-10.

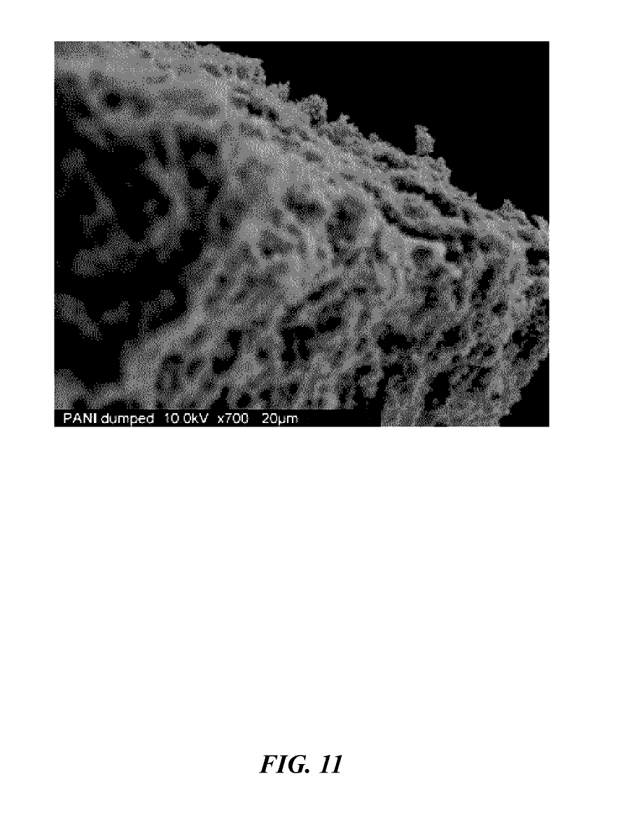

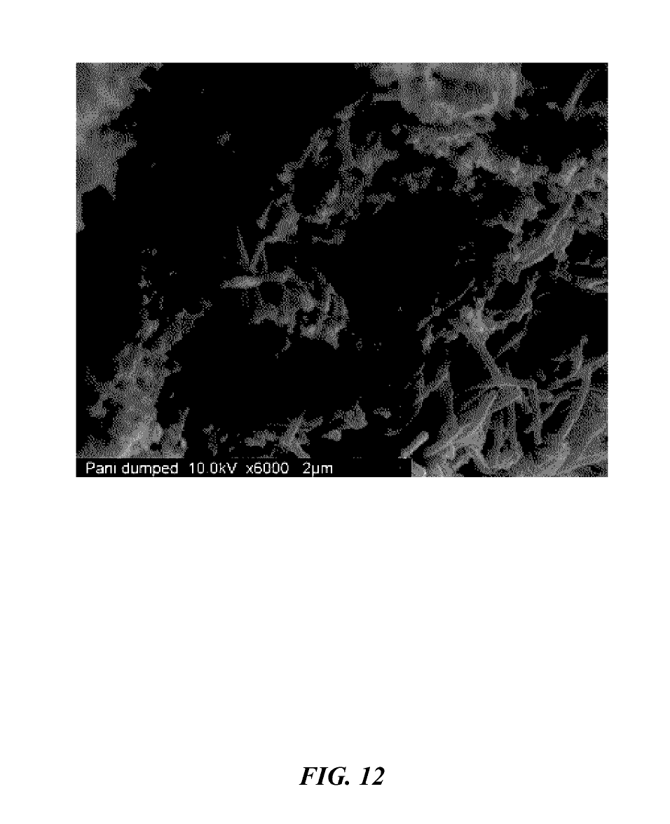

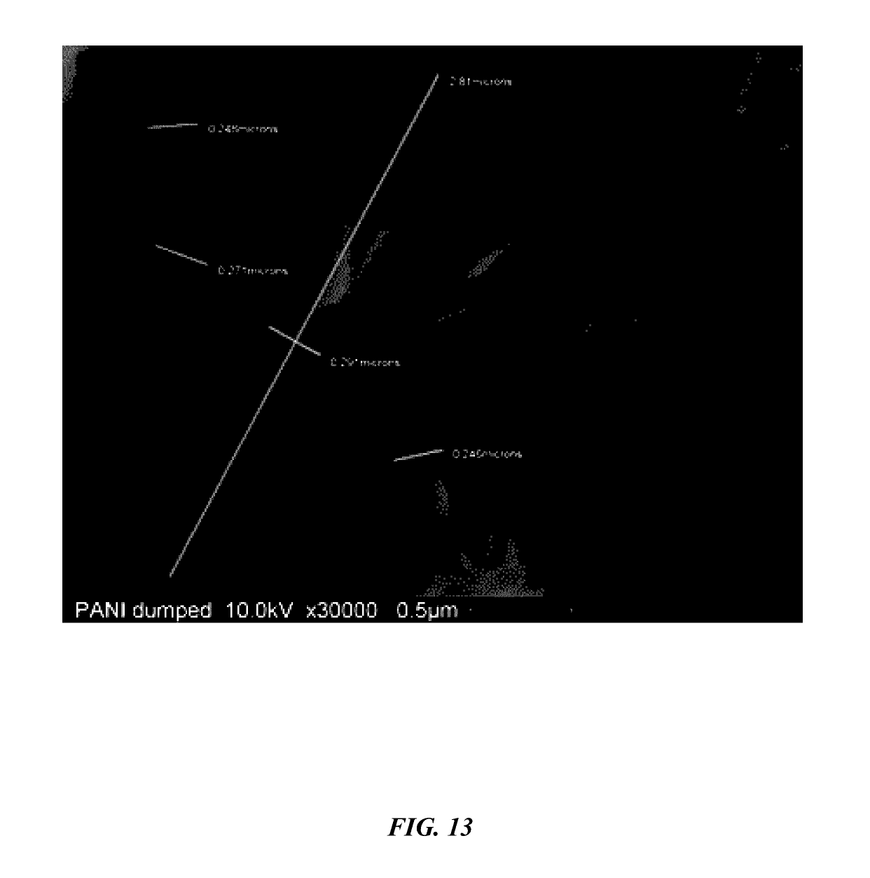

In an effort to gain pure PANI nanofibers, the reaction was repeated again but without stirring or agitation of any sort. The three solutions were dumped one after the other and allowed to sit for around 15 mins. It was then placed in the refrigerator at 5° C. for 15 hrs and decanted and dried. Conforming to Kaner's results, the SEM showed extensive nanofibers formation as can be observed in FIG. 11. Longer more pronounced nanofibers are also obtained. FIG. 12 shows more nanofibers and less agglomeration. FIG. 13 shows the measured parameters of the fibers having a length of 2.8 μm and width of about 248 nm.

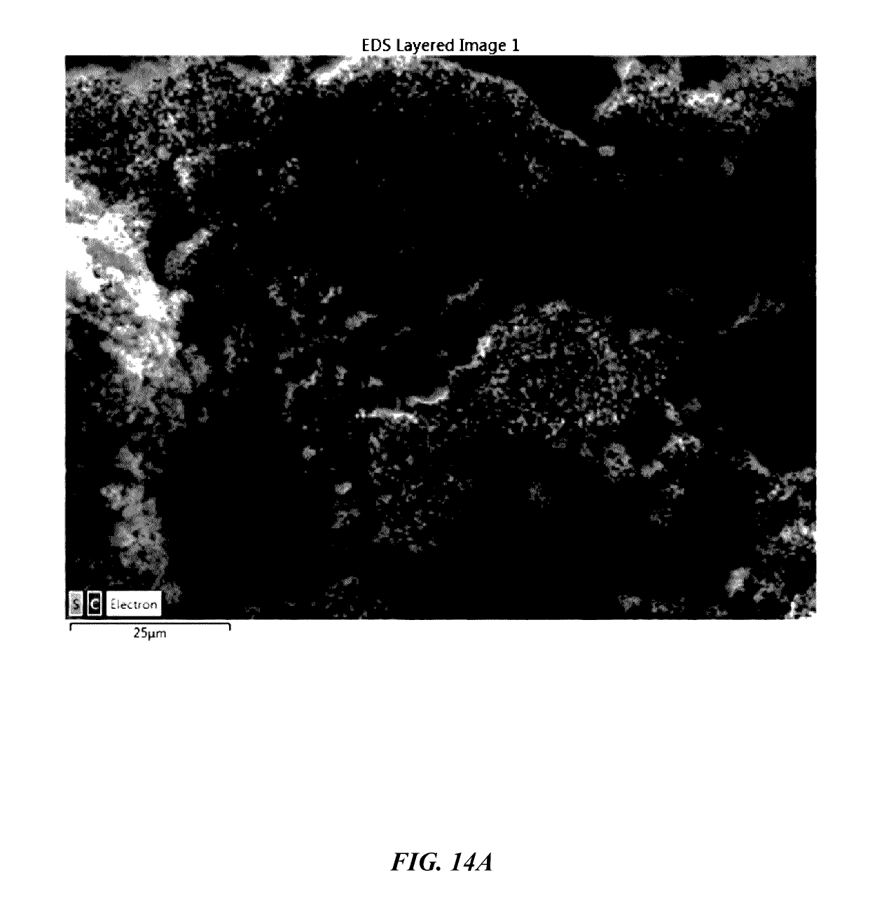

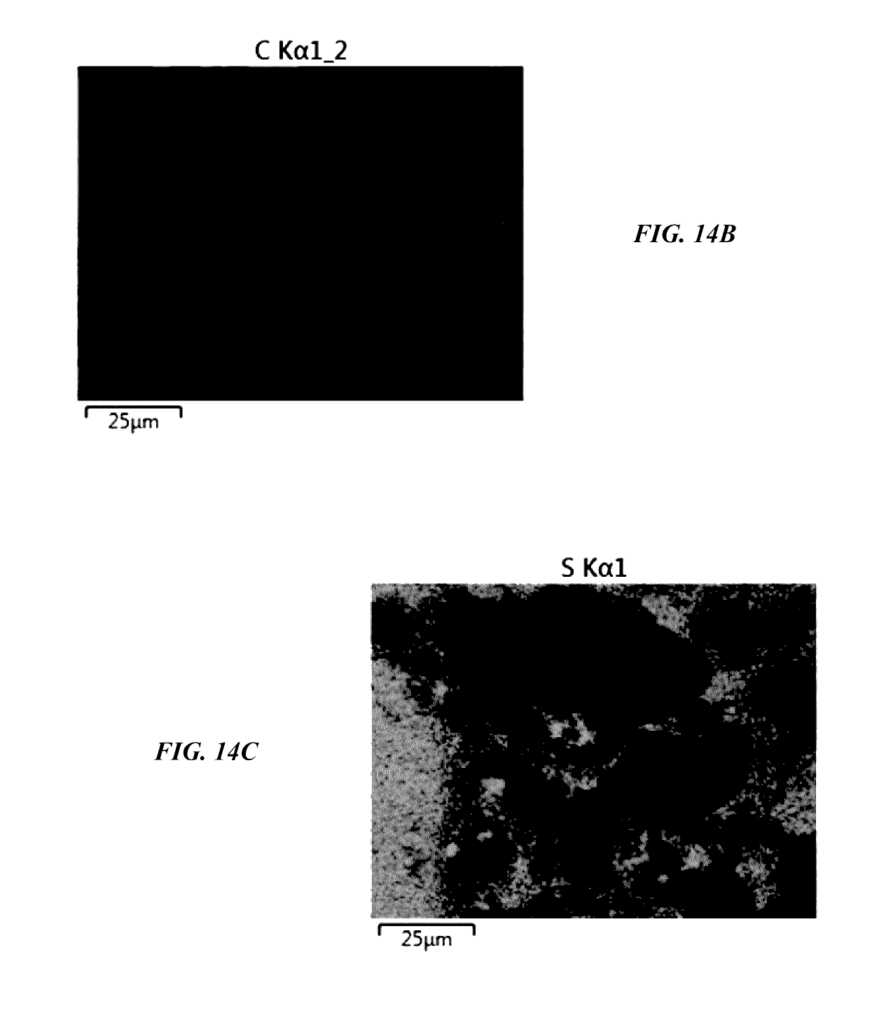

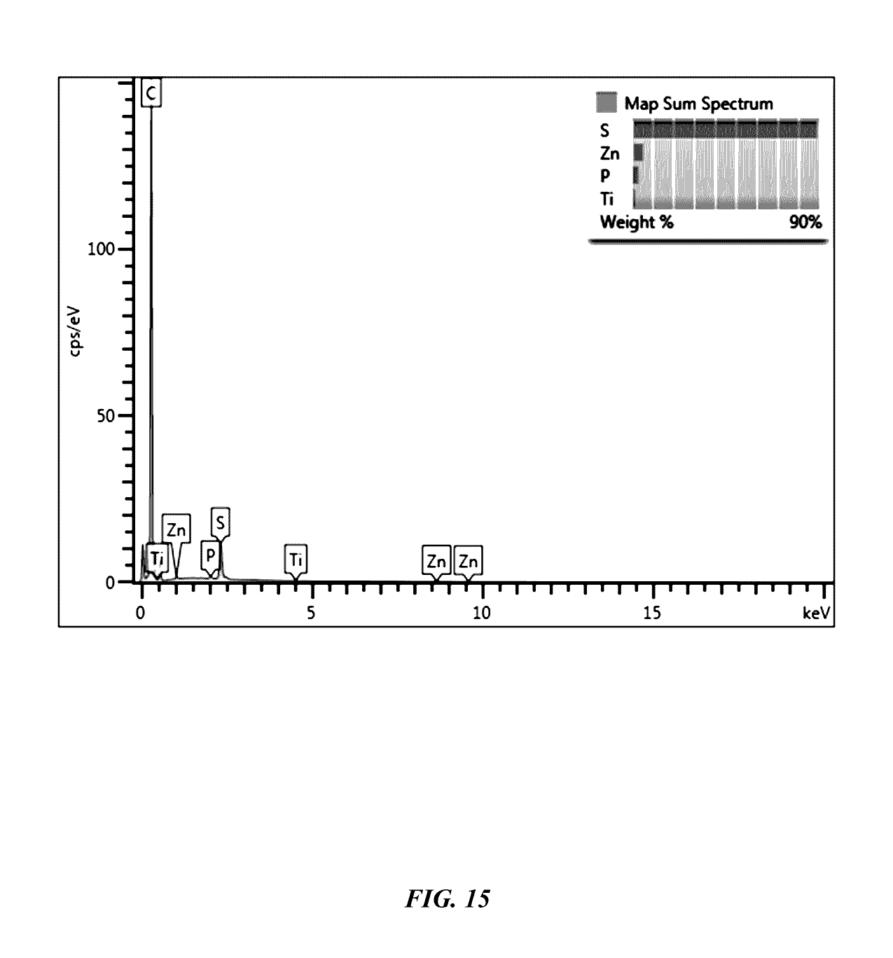

Energy dispersive x-ray mapping and spectral analysis (see FIG. 15) was carried out using an Oxford EDS detector mounted on an SEM microanalysis instrument. Based on the EDS layered image, the chemical composition of the PANI included primarily carbon and sulfur, and it is well aligned with the PANI molecular structure. The EDS spectral response exhibited both carbon and sulfur peaks (see FIGS. 14A-14C) in addition to minor impurities like Zn.

### CONCLUSIONS

Polyaniline nanofibers were successfully synthesized and growth thereof optimized by wet chemical method and characterized these PANI using SEM and EDS micro analyses studies. This study is relevant to certain embodiments of the current invention, particularly as it relates to formation/growth of nanofibers to fill the cracks of the support material in the fuel cell.

### REFERENCES

1. J. Huang, R. B. Kaner, “A general chemical route to polyaniline nanofibers”, J. Am. Chem. Soc., 126, (2004), pp. 851-855

2. J. Huang, S. Virji, B. H. Weiller, R. B. Kaner, “Polyaniline Nanofibers: Facile Synthesis and Chemical Sensors”, J. Am. Chem. Soc., 125, (2003), pp. 314-315

3. S. Virji, R. B. Kaner and B. H. Weiller, “Hydrogen sensors based on conductivity changes in polyaniline nanofibers”, J. Phys. Chem. B, 110, (2006), pp. 22266-22270

4. J. Huang and R. B. Kaner, “Nanofiber formation in the chemical polymerization of aniline: A mechanistic study”, Angew. Chem. Int. Ed., 43, (2004), pp. 5817-5821.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A fuel cell support material, comprising:
a plurality of nano-reservoirs storing monomers, wherein the nano-reservoirs are adapted to release the monomers upon corrosion of the support material and the monomers are convertible into nanofibers when subject to a radical rich oxidative environment at an electrode of a fuel cell.

2. A fuel cell, comprising:
a catalyst support material including nano- or micro-encapsulated monomers and oligomers containing a conducting polymer,
said monomers and oligomers being coated with an inorganic or organic shell material to achieve the nano- or micro-encapsulation,
said monomers and oligomers structured to burst into nanofibers of said conducting polymer to fill cracks in said catalyst support material due to oxidative degradation of said catalyst support material at an electrode of said fuel cell,
said monomers and oligomers being a physical barrier to catalyst agglomeration.

3. A fuel cell as in claim 2, further comprising:
said conducting polymer including polyaniline.

4. A fuel cell as in claim 2, further comprising:
said catalyst support material further including graphene oxide reduced with a reducing agent to facilitate self-healing of said catalyst support material.

5. A fuel cell as in claim 2, further comprising:
said shell material incorporating a hydrophobic character in said catalyst support material that improves mass activity and decreases a flooding effect at said electrode.

6. A method of generating nanofibers of conducting polymers in a fuel cell in situ, comprising:
encapsulating a plurality of monomers and oligomers with an organic or inorganic shell material;
storing said plurality of monomers and oligomers in a plurality of micro- or nano-reservoirs, wherein the monomers and oligomers include a conducting polymer that converts into nanofibers when subject to a radical rich oxidative environment at an electrode of said fuel cell,
said micro- or nano-reservoirs developing micro-cracks at outer surfaces thereof to release said monomers and oligomers as a result of degradation of a substrate or support material in said fuel cell, said degradation including cracks in said substrate or support material,
said monomers and oligomers flowing into said cracks to react with said radical rich oxidative environment and generate said nanofibers of said conducting polymer in situ, wherein said nanofibers plug said cracks and reverse said degradation on the surface of said substrate or support material by re-bonding said cracks and preventing shrinkage of said support material and dislocation of the electrocatalyst without affecting the conductivity of said support material.

7. A method as in claim 6, further comprising:
said conducting polymer including polyaniline.

8. A method as in claim 6, further comprising:
said catalyst support material further including graphene oxide reduced with a reducing agent to facilitate self-healing of said catalyst support material.

9. A method as in claim 6, further comprising:
said shell material incorporating a hydrophobic character in said catalyst support material that improves mass activity and decreases a flooding effect at said electrode.
